(19) United States
(12) Patent Application Publication
(10) Pub. No.: US 2026/0118826 A1
(43) Pub. Date: Apr. 30, 2026

(54) WATCHCASE WITH ROTATING BEZEL

(71) Applicant: ETA SA Manufacture Horlogère Suisse, Grenchen (CH)

(72) Inventors: Raphaël BALMER, Vicques (CH); Adrien Keller, Neuchâtel (CH)

(73) Assignee: ETA SA Manufacture Horlogère Suisse, Grenchen (CH)

(21) Appl. No.: 19/360,316

(22) Filed: Oct. 16, 2025

(30) Foreign Application Priority Data
Oct. 28, 2024 (EP) 24209252.6

(51) Int. Cl. G04B 19/28

(52) U.S. Cl. CPC G04B 19/283

(57) ABSTRACT

A watchcase (1) including a glass (2) and a rotating bezel (3). One of the glass and of the rotating bezel includes at least one resilient blade (4) arranged to engage with a toothing (5) included on the other of the glass and of the rotating bezel, to angularly index the position of the rotating bezel relative to the glass and therefore to the middle. Preferably, the resilient blade (4) extends from the glass (2) and the toothing is formed by the bezel (3) inside said rotating bezel. In an advantageous variant, the rotating bezel (3) and the glass (2) are arranged such that the rotating bezel can be clipped onto the glass.

### CROSS REFERENCE TO RELATED APPLICATION

This application claims priority to European Patent Application No. 24209252.6 filed Oct. 28, 2024, the entire contents of which are incorporated herein by reference.

### TECHNICAL FIELD

This invention relates to the field of mechanical horology. More specifically, it relates to a watchcase fitted with a rotating bezel.

### PRIOR ART

There are many exemplary embodiments of timepieces with rotating bezels. The rotating bezel is usually rotationally fitted to the middle of the watchcase. These rotating bezels usually have a graduation in minutes and offer a simple means of measuring time or of indicating the time in a second time zone. To keep the rotating bezel in position, an indexing device is provided, which enables the bezel to be positioned in defined angular positions, in particular 60 positions. This indexing device is made using flexible blades acting as a click that bears against a toothing. The toothing is secured to the rotating bezel by being formed either directly on the non-visible inner face of the bezel or on an attached ring assembled with the bezel and thereby forming part of the bezel. The flexible blades extend from an annular ring, generally made of steel, which is secured to the middle.

Application EP2672333 gives an example of a rotating bezel fitted so as to pivot on a middle and its indexing device. It consists of an added toothing and of a ring carrying three flexible blades, forming clicks.

Application EP0573386 describes a particular embodiment in which the rotating bezel is clipped between the middle and an upper annular protrusion of the glass. As in the other embodiments, the rotating bezel comprises a toothing on its inner face. An annular ring comprising four flexible blades is placed between the middle and the bezel.

These designs have a number of drawbacks, particularly for timepieces with a plastic case. The use of added elements increases the complexity and cost of the timepiece. In particular, the annular ring must be securely fastened to the middle to enable the rotating bezel to be indexed. Moreover, the annular ring is generally made of metal. If the flexible blades are metallic, the toothing should also be made of metal to avoid premature wear.

The invention aims to remedy the various drawbacks of the devices in the prior art and to provide a watchcase with a rotating bezel that is made with a few specific elements and is relatively inexpensive.

### SUMMARY OF THE INVENTION

The main purpose of the invention is achieved by a watchcase that comprises a glass and a rotating bezel, one of the glass and of the rotating bezel comprising at least one resilient blade arranged to engage with a toothing comprised on the other of the glass and of the rotating bezel, so as to angularly index the position of the rotating bezel relative to the glass.

The design of the watchcase according to the invention makes it easy and cost-effective to achieve angular indexing of the bezel with reference to the glass.

According to a particular embodiment of the invention, said at least one resilient blade and the toothing are arranged to form a unidirectional system enabling the rotating bezel to be rotated in a single direction, preferably counterclockwise.

According to an advantageous embodiment of the invention, said at least one resilient blade extends from the glass and the toothing is formed by the rotating bezel inside this rotating bezel.

According to a preferred embodiment of the invention, the rotating bezel is fitted so as to pivot on the glass. In particular, the rotating bezel and the glass are arranged such that the rotating bezel can be clipped onto the glass.

According to a first general embodiment of the invention, said at least one resilient blade is arranged to distort in a direction parallel to the axis of rotation of the rotating bezel, the toothing being arranged above said at least one resilient blade.

According to a second general embodiment of the invention, said at least one resilient blade is arranged to distort in a direction orthogonal to the axis of rotation of the rotating bezel, the toothing being arranged at the level of said at least one resilient blade, at the periphery of said at least one resilient blade.

### BRIEF DESCRIPTION OF THE DRAWINGS

Certain purposes, advantages and characteristics of the present invention will become apparent on reading several embodiments provided solely by way of non-limiting examples, with reference to the appended drawings in which:

FIG. 1 shows a perspective view of a rotating bezel and a glass, in a separate configuration before assembly, forming a watchcase assembly according to a first embodiment of the invention,

FIG. 2 shows a close-up view of the glass near a resilient blade comprised in the glass,

FIG. 3 is a horizontal cross-section of the glass and of the rotating bezel fitted in the watchcase in the first embodiment, at the level of the toothing and of the resilient blade,

FIG. 4 is a partial vertical cross-section of the glass and of the rotating bezel fitted on this glass, made in the watchcase in the first embodiment,

FIG. 5 shows an exploded perspective view of an assembly comprising a glass and a rotating bezel and forming a watchcase according to a second embodiment of the invention.

### DETAILED DESCRIPTION OF THE EMBODIMENTS OF THE INVENTION

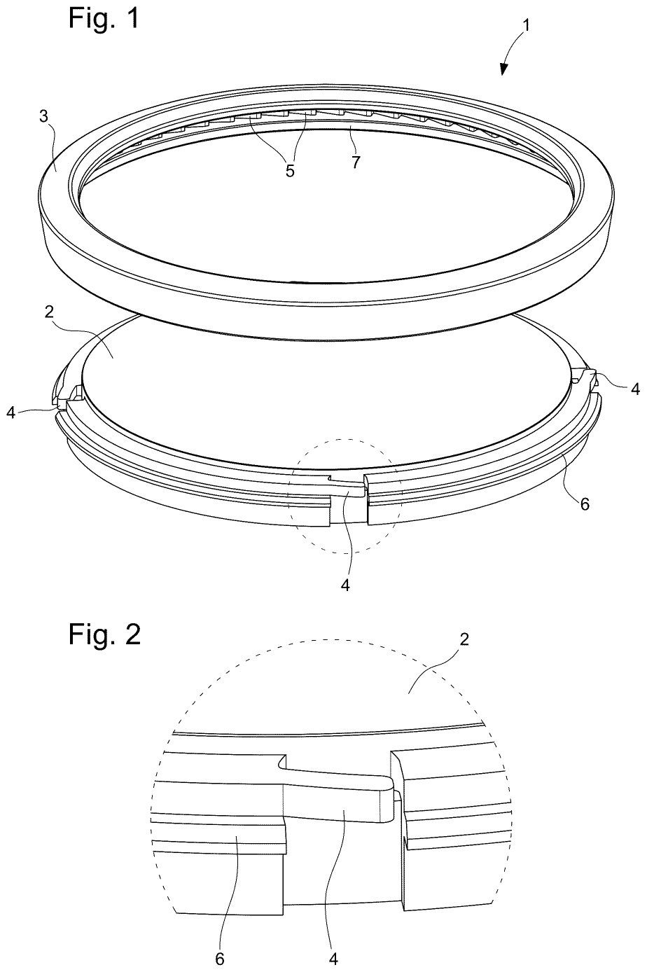

FIGS. 1 to 4 show an assembly consisting of a glass 2 and of a rotating bezel 3 forming a watchcase 1 according to a first embodiment of the invention. This assembly is designed to close the middle of the timepiece. The glass 2 is meant to be secured to the middle by gluing, soldering or any other appropriate means. Only the glass and the rotating bezel are shown in the figures. The other parts of the watchcase 1 are known to the person skilled in the art.

The rotating bezel 3 is designed to be fitted so as to pivot directly on the glass 2. To this end, the glass comprises a lateral protrusion 6 extending around its periphery, while the rotating bezel 3 comprises a lower flange 7, continuous or in several separate sectors, on its inner face. Bevelled surfaces on the lateral protrusion 6 and the flange 7 make it easier to force-fit the rotating bezel onto the glass. Pressing in the direction of the bezel's axis of rotation thus enables the rotating bezel to be clipped onto the glass.

A toothing 5 is formed by the rotating bezel 3 inside this rotating bezel. In a novel manner, the glass 2 comprises at least one resilient blade 4, arranged to engage with the toothing 5 formed on an inner lateral surface of the rotating bezel 3. In the first embodiment shown, there are four resilient blades 4 arranged to distort in a direction orthogonal to the axis of rotation of the rotating bezel, the toothing being arranged above the resilient blades. In the preferred variant shown, the resilient blades 4 extend from the glass 2. In other words, the resilient blades 4 are made in one piece with the glass 2, which is preferably made of a plastic material. Advantageously, the rotating bezel is also made of a plastic material.

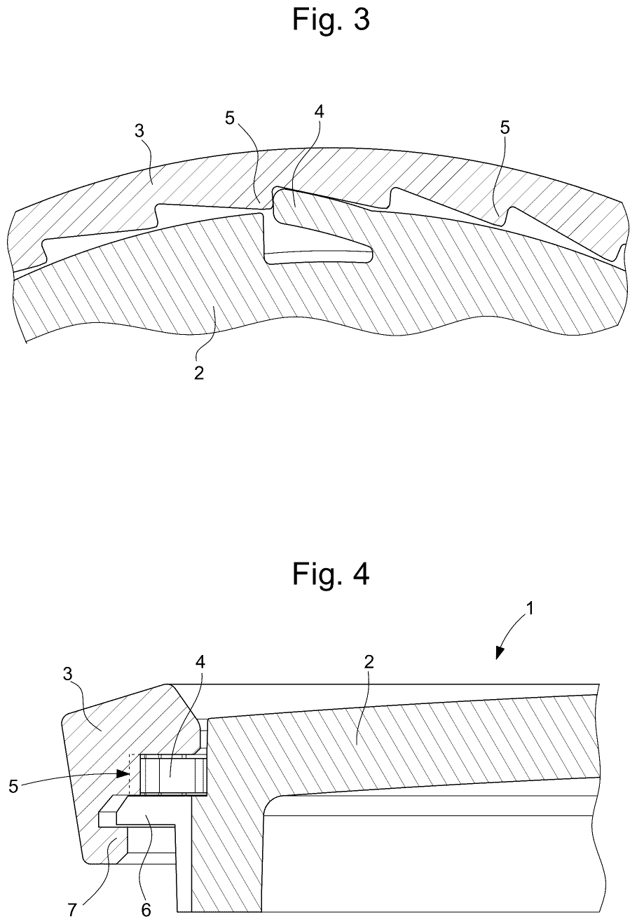

FIG. 3 shows a close-up view of a flexible blade 4 and of the toothing 5. The pressure exerted by the flexible blades against the toothing enables the rotating bezel to be indexed relative to the glass, and therefore to the middle, in preset angular positions.

In the variant embodiment shown, the toothing 5 has a sawtooth profile which, together with the resilient blades 4, forms a unidirectional system enabling the glass to be rotated in one direction only. In this case, the rotating bezel 3 can only be turned counterclockwise.

It is of course understood that the invention is not limited to this particular toothing and covers any other type of profile enabling angular indexing of the rotating bezel.

In a variant of the first embodiment, not shown, the resilient blades can be positioned at the same level as the lateral protrusion to reduce the thickness of the glass and of the bezel.

Preferably, the glass 2 is made of injection-moulded plastic. To make the mould easier to produce, the lateral protrusion 6 is discontinued at the level of the resilient blades 4.

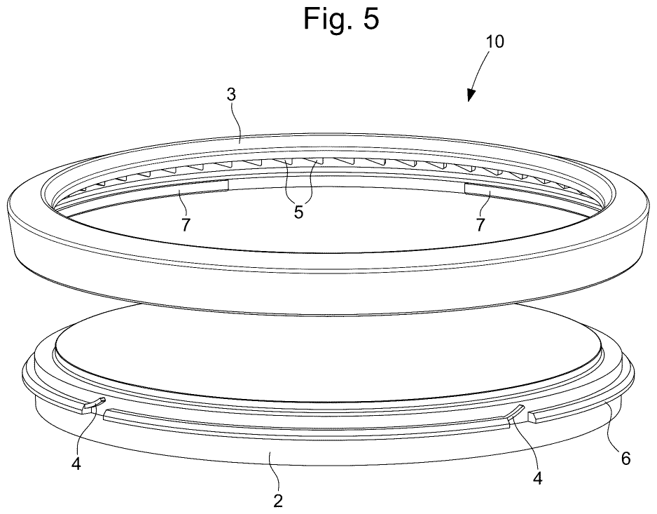

FIG. 5 shows a second embodiment of a rotating bezel and glass system according to the invention, in which the elastic blades 4 are arranged to distort parallel to the direction of the axis of rotation of the bezel. The toothing 5 is formed accordingly to engage with the resilient blades 4 and enable angular indexing of the rotating bezel 3. The sawtooth profile of the toothing makes it possible to restrict the rotation of the bezel to counterclockwise.

The invention also relates to other embodiments not shown. The resilient blades could thus be carried by the rotating bezel and the toothing formed by the glass. Preferably, the resilient blades extend from the rotating bezel and are located on its inside. In other words, the resilient blades are made of the same material as the rotating bezel. As in the embodiments shown, the resilient blade could be distorted in a direction parallel or perpendicular to the axis of rotation of the rotating bezel. The rotating bezel with the resilient blades can be produced by injection moulding or by additive manufacturing methods. The rotating bezel is preferably made of plastic.

The invention enables an assembly comprising a glass and a rotating bezel to be produced with considerably fewer resources, eliminating the risks associated with the use of an additional metal ring and simplifying the operations involved in assembling the timepiece.

1. A watchcase comprising a glass and a rotating bezel; wherein one of the glass and of the rotating bezel comprises at least one resilient blade arranged to engage with a toothing comprised on the other of the glass and of the rotating bezel, so as to angularly index the position of the rotating bezel relative to the glass.

2. The watchcase according to claim 1, wherein said at least one resilient blade and the toothing are arranged to form a unidirectional device enabling the rotating bezel to be rotated in a single direction, in particular counterclockwise.

3. The watchcase according to claim 1, wherein said at least one resilient blade extends from the glass, and in that the toothing is formed by the rotating bezel inside this rotating bezel.

4. The watchcase according to claim 1, wherein the rotating bezel is fitted to pivot on the glass.

5. The watchcase according to claim 4, wherein the rotating bezel and the glass are arranged such that the rotating bezel can be clipped onto the glass.

6. The watchcase according to claim 1, wherein said at least one resilient blade is arranged to distort in a direction parallel to the axis of rotation of the rotating bezel, and in that the toothing is arranged above said at least one resilient blade.

7. The watchcase according to claim 1, wherein said at least one resilient blade is arranged to distort in a direction orthogonal to the axis of rotation of the rotating bezel, and in that the toothing is arranged at the level of said at least one resilient blade, at the periphery of said at least one resilient blade.

8. The watchcase according to claim 1, further comprising at least three resilient blades engaging with the toothing.

9. A timepiece comprising the watchcase according to claim 1.
